(19) United States
(12) Patent Application Publication
(10) Pub. No.: US 2004/0050543 A1
(43) Pub. Date: Mar. 18, 2004

(54) High/low temperature water cooling system

(76) Inventors: Young Jin Kim, Kyungsangnam (KR); Yi Seok Song, Kyungsangnam (KR)

Correspondence Address: LADAS & PARRY, 26 WEST 61ST STREET, NEW YORK, NY, 10023, US

(21) Appl. No.: 10/433,069

(22) PCT Filed: Nov. 27, 2001
(86) PCT No.: PCT/KR01/02042

(30) Foreign Application Priority Data
Dec. 11, 2000 (KR) 2000/75225

(51) Int. Cl. B60H 1/00; G05D 23/00; B61D 27/00; B60H 3/00

(52) U.S. Cl. 165/202; 165/300; 165/43

(57) ABSTRACT

The present invention relates to a high/low temperature water cooling system. The high/low temperature water cooling system according to the present invention is formed of a high temperature cooling water circulation circuit and a low temperature cooling water circulation circuit which are formed through the high temperature heat exchanger and low temperature heat exchanger of the heat exchanger, so that the high temperature cooling water heated by the engine is heat-exchanged with an external air in the high temperature heat exchanger and then is used for cooling the engine. A part of the cooling water cooled by the high temperature heat exchanger is re-cooled using the low temperature heat exchanger for thereby cooling the charge air and oil which circulate in the charge air cooler and oil cooler.

### BACKGROUND OF THE INVENTION

1. Field of the Invention

The present invention relates to a high/low temperature water cooling system capable of cooling a heated medium like a cooling water using a heat exchanger and different medium like an engine, air or oil using a cooled heat medium, and in particular to a high/low temperature water cooling system which is capable of dividing and cooling a heated medium (cooling water) into a high temperature heat medium and a low temperature medium using each circulation circuit of a heat exchanger having a plurality of separated or stacked circulation circuits for thereby cooling a plurality of cooling objects each having a different operation temperature like an engine or oil cooler using each heat medium.

2. Description of the Background Art

Generally, an effective mechanical energy among a heat capacity of a fuel supplied to an engine of a vehicle, namely, an energy used for driving a wheel is about 30%, and the remaining 70% of energy is lost as heat and a mechanical friction. About 30% among the loss of the energy of the vehicle is a heat loss due to an exhaustion, and 10% is a mechanical friction loss, and the remaining 30% is a cooling loss due to an artificial cooling. The above lost energy is discharged in the air as a heat form.

In the case that the exhaustion loss among the energy losses of the vehicle, a combustion gas is discharged from a cylinder in a high temperature and high pressure state, so that it is impossible to withdraw. When the cooling loss is decreased, the engine is operated at a high temperature state, and a lubricating limit of the lubricant is exceeded for thereby damaging the engine. On the contrary, it is over-cooled, since a large capacity of heat among the heat energy is lost for a cooling operation based on the combustion, the heat efficiency of the engine is decreased, and the consumption of the fuel is increased.

In order to enhance a combustion ratio, a highly integrated heat exchanger is developed and module-fabricated. A cooling water circulation system is developed for thereby decreasing the loss of a heat energy. Namely, various studies for enhancing the efficiency of energy are conducted.

In the case of a 2000 cc displacement vehicle, if the engine revolution is 6000 rpm in the maximum performance, one cycle is completed in 0.02 seconds. At this time, the mixed gas is inputted into a combustion chamber at a speed of 30-50 m/s, and the exhaust gas is outputted at a speed of 80-90 m/s. In addition, the exhaust gas discharged to an exhaust system rotates the turbine of a charger and compresses the air at a pressure higher than atmosphere. The compressed charge air is cooled by a charge air cooler and is charged into the combustion chamber. Therefore, the density of the charge air is increased, so that more air is charged into the combustion chamber. Therefore, the fuel injection amount is increased, and the combustion efficiency and engine power are enhanced.

In addition, in an air cooling system in which a circulating heat medium is cooled as an external is blown to various heat exchangers using a cooling fan and flows through the heat exchangers for thereby cooling the heat medium, since a plurality of heat exchangers such as a radiator, charge air cooler, oil cooler, condenser, etc. are installed in front of one cooling fan in a stacked structure, a large air blowing amount and heat radiating area are required for cooling the above heat exchangers to the optimum temperature. Therefore, in the air cooling system, it is difficult to arrange and install the heat exchangers, so that there is a limit for using the space of the vehicle. In addition,.the connection hose for circulating the heat medium therethrough is long, and the construction of the same is complicated.

In the heat exchangers which form the air cooling system, in the case of the charge air cooler for cooling air supplied to the engine, as the heat head is high, the density of the charge air is increased. Therefore, it is possible to enhance the power of the engine, and it is possible to decrease the fuel consumption. As the cooling ratio is high, it is more efficient. In the case of the oil cooler, a bidirectional temperature control, namely, heating and cooling, is required for maintaining a certain viscosity. Each heat exchanger of the air cooling system requires a temperature control based on each characteristic. In the case of the conventional air cooling system, it is constituted in such a manner that the air blown by the cooling fan of a single assembled structure concurrently cool all heat exchangers. In this case, the heat is mixed between the stacked heat exchangers. Therefore, it is impossible to implement a temperature control based on each characteristic with respect to the heat exchangers.

In the case of the conventional high/low temperature radiator which is used when a fluid is gas and has a small convection current heat transfer coefficient, it is generally constituted in a compact shape in which a fin tube or plat plate are densely arranged. In order to increase the radiating performance, a large amount of air blowing is required. Therefore, a mechanism energy is additionally needed. In order to enhance a heat transfer surface area (radiating area) per unit volume, the fin pitch is densely formed for thereby increasing the number of mounts of the fins. In this case, the fabrication cost is increased.

### SUMMARY OF THE INVENTION

Accordingly, it is an object of the present invention to provide a high/low temperature water cooling system in which a heat medium circulation path, namely, a cooling water circulation path is divided into a high temperature heat medium circulation path formed in such a manner that the engine is cooled to a proper temperature by radiating the heat generated in the engine and a low temperature heat medium circulation path which is formed in such a manner that a charge air cooler and oil cooler each having a proper diving temperature lower than that of the engine are cooled, so that a cooling object such as an engine, charge air cooler, oil cooler, etc. which have different operation temperatures is cooled based on the characteristic. In order to achieve the above objects, there is provided a high/low temperature water cooling system which includes a heat exchanger integrally formed of a high temperature heat exchanger for cooling a cooling water flown in from an engine by heat-exchanging the cooling water with an external air and a low temperature heat exchanger for receiving a part of the cooling water, which is cooled and discharged from the high temperature heat exchanger, from a water pump and heat-exchanging the cooling water again with an external air, a charge air cooler for receiving a cooling water from the low temperature heat exchanger and heat-exchanging the cooling water with a charge air from an engine combustion chamber and cooling the charge air, an oil cooler for receiving a cooling water from the charge air cooler and heat-exchanging the cooling water with an oil which circulates along an oil circulation circuit, a water pump for pumping a cooling water discharged from the high temperature heat exchanger and the oil cooler and transferring to a water jacket of the engine, and

a thermostat for inducing a cooling water discharged from the engine in the direction of the high temperature heat exchanger in the case that the temperature of the cooling water exceeds a certain reference temperature and bypassing the cooling water in the case that the temperature of the cooling water is below a certain reference temperature.

The heat exchanger is formed of an inlet tank and an outlet tank arranged in parallel at a distance therebetween, and a heat radiating core for connecting the inlet tank and the outlet tank, flowing the cooling water and heat-exchanging the cooling water with an external air, wherein second discharging port connected with an inlet connected with a discharging side of the cooling water of the engine and an inlet of the charge air cooler is installed in a space formed in such a manner that the inner space of the inlet tank is divided into two spaces by a partition, and a first discharging port connected with the water pump is installed in the outlet tank in deviation with the inlet side, for thereby forming a high temperature heat exchanger in which a cooling water discharged from the engine through the inlet is flown and first cooled through the heat radiating core, and a part of the cooling water is discharged in the direction of the water pump through a first discharging port of the outlet tank, and a low temperature heat exchanger in which a remaining part of the first cooled cooling water is flown in to the heat radiating core and is second-cooled, and is discharged to the charge air cooled through the second discharging port.

The heat exchanger includes an inlet tank and an outlet tank arranged in parallel at a certain distance therebetween, and a heat radiating core which connects the inlet tank and the outlet tank and flows the cooling water and heat-exchanges the cooling water with an external air, wherein the inlet tank, the outlet tank and the heat radiating core are separated in the left and right directions with respect to the same surface for thereby forming a high temperature heat exchanger in which the cooling water is discharged from the engine in the direction of the water pump which first-cools the cooling water as a part of the inlet tank, the outlet tank and the heat radiating core, and a low temperature heat exchanger in which the cooling water discharged from the water pump is second-cooled and is discharged in the direction of the charge air cooler as the other side of each of the inlet tank, the outlet tank and the heat radiating core.

The heat exchanger includes an inlet tank and an outlet tank which are arranged in parallel at a certain distance therebetween, and a heat radiating core for connecting the inlet tank and the outlet tank and flowing the cooling water and heat-exchanging the cooling water with an external air, wherein front and rear portions are formed in which the inlet tank, the outlet tank and the heat radiating core are arranged in the front and rear directions with reference to the same surface, and a high temperature heat exchanger discharges the cooling water discharged from the engine in the direction of the water pump which first-cools the cooling water as a rear part of the inlet tank, the outlet tank and the heat radiating core, and a low temperature heat exchanger second-cools the cooling water discharged from the water pump and discharges into the direction of the charge air cooler as a front part of the inlet tank, the outlet tank and the heat radiating core.

The heat exchanger includes an inlet tank and an outlet tank arranged in parallel at a certain distance therebetween, and a heat radiating core which connects the inlet tank and the outlet tank and flows the cooling water and heat-exchanges the cooling water with an external air, wherein a high temperature heat exchanger is divided into a front portion, intermediate portion and rear portion in which the inlet tank, the outlet tank and the heat radiating core are arranged in the forward and rearward directions with reference to the same surface and discharges the cooling water discharged from the engine in the direction of the water pump which first-cools the cooling water as a front part of the inlet tank, the outlet tank and the heat radiating core, and a low temperature heat exchanger second-cools the cooling water discharged from the water pump and discharged the cooling water in the side of the charge air cooler as each intermediate part and a rear part of the inlet tank, the outlet tank and the heat radiating core.

In order to achieve the above objects, there is provided a high/low temperature water cooling system which includes a heat exchanger which is integrally formed of a high temperature heat exchanger for heat-exchanging and cooling a cooling water flown in from an engine with an external air, and a low temperature heat exchanger which forms a separate cooling water line and receives a cooling water discharged from an oil cooler and heat-exchanges the cooling water with an external air, a first water pump for pumping a cooling water discharged form the high temperature heat exchanger in the direction of the engine and circulating the same, a thermostat for inducing the cooling water discharged from the engine in the direction of the high temperature heat exchanger in the case that the temperature of the cooling water exceeds a certain reference temperature and bypassing the cooling water using the first water pump in the case that the temperature of the same is below a certain reference temperature, a charge air cooler for receiving a cooling water discharged from the low temperature heat exchanger and heat-exchanging with a charge air supplied to an engine combustion chamber and cooling the charge air, an oil cooler for receiving a cooling water discharged from the charge air cooler and heat-exchanging with an oil which circulates along an oil circulation circuit, and a second water pump for pumping the cooling water discharged from the oil cooler and circulating the pumped cooling water in the direction of the low temperature heat exchanger.

The heat exchanger includes an inlet tank and an outlet tank arranged in parallel at a certain distance therebetween, and a heat radiating core which connects the inlet tank and the outlet tank and flows the cooling water and heat-exchanges the cooling water with an external air, wherein a high temperature heat exchanger is divided into a front portion, intermediate portion and rear portion in which the inlet tank, the outlet tank and the heat radiating core are arranged in the forward and rearward directions with reference to the same surface and discharges the cooling water discharged from the engine in the direction of the water pump which first-cools the cooling water as a front part of the inlet tank, the outlet tank and the heat radiating core, and a low temperature heat exchanger second-cools the cooling water discharged from the water pump and discharged the cooling water in the side of the charge air cooler as each intermediate part and a rear part of the inlet tank, the outlet tank and the heat radiating core.

### BRIEF DESCRIPTION OF THE DRAWINGS

The present invention will become better understood with reference to the accompanying drawings which are given only by way of illustration and thus are not limitative of the present invention, wherein;

FIG. 1 is a block diagram illustrating a high/low temperature water cooling system according to an embodiment of the present invention;

FIG. 2 is a block diagram illustrating a high/low temperature water cooling system according to another embodiment of the present invention;

FIG. 3 is a view illustrating a first example of a heat exchanger according to the present invention;

FIG. 4 is a view illustrating a second example of a heat exchanger according to the present invention;

FIG. 5 is a view illustrating a third example of a heat exchanger according to the present invention;

FIG. 6 is a view illustrating a fourth example of a heat exchanger according to the present invention;

FIG. 7 is a view illustrating a fifth example of a heat exchanger according to the present invention; and

FIG. 8 is a view illustrating an eighth example of a heat exchanger according to the present invention.

### DETAILED DESCRIPTION OF THE PREFERRED EMBODIMENTS

The construction, operation and effects of the water cooling heat exchanger according to the present invention will be explained with reference to the accompanying drawings.

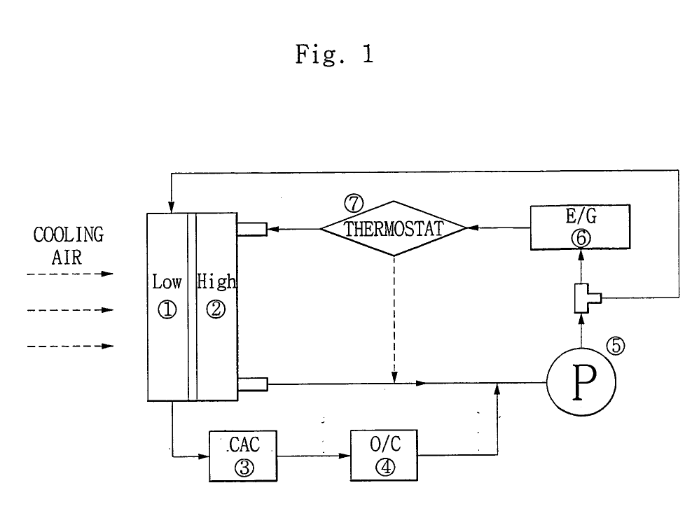

FIG. 1 is a view illustrating a high/low temperature water cooling system according to the present invention.

As shown therein, the high/low temperature water cooling system according to the present invention includes heat exchangers 1 and 2 which have a water cooling circulation path divided into a high temperature water cooling circulation path for radiating the head generated in an engine 6 of a vehicle and preventing an over heating and maintaining a proper temperature and a low temperature water cooling circulation path for cooling a charge air cooler 3 and an oil cooler 4 and mix a cooling water flowing through each cooling water circulation path by one water pump 5 for thereby implementing an integration type cooling system and is integrally formed of a high temperature heat exchanger 2 and a low temperature heat exchanger 1, a charge air cooler 3 connected with an outlet of the low temperature heat exchanger 1, an oil cooler 4 connected with an outlet of the charge air cooler 3, a water pump 5 connected with the outlet of the high temperature heat exchanger 2 and the outlet of the oil cooler 4, and a thermostat 7 connected with a cooling water outlet of the engine.

In the thusly constituted high/low temperature water cooling system, a combustion heat is absorbed by a cooling water which circulates in the engine 6 and the high temperature heat exchanger 2 of the heat exchangers 1 and 2 based on a pumping operation of the water pump 5 for thereby cooling the engine. The low temperature heat exchanger 1 of the heat exchangers 1 and 2 receives a part of the cooling water first-cooled by the high temperature heat exchanger 2 and pumped by the water pump 5 and then the cooling water is second-cooled and is circulated along a circulation path through the charge air cooler 3 and the pil cooler 4. The cooling water which is cooled by the low temperature heat exchanger 1 cools the charge air supplied to the combustion chamber and the oil which circulates along an oil circulation path.

The charge air cooler 3 heat-exchanges the charge air supplied to the engine combustion chamber with the cooling water which is cooled again by the low temperature heat exchanger 1 and decreases the temperature of the charge air to near the temperature of the atmosphere for thereby increasing the density of the charge air and enhancing the power of the engine.

In addition, the oil cooler 4 heat-exchanges the cooling water outputted from the charge air cooler 3 with the oil and increases the heat of the cooling water in the case that the temperature of the oil is low and decreases the temperature using the cooling water which has a relatively low temperature in the case of the over-heat for thereby implementing a constant temperature of the oil. As the oil has a constant temperature, a fluid friction loss which occurs based on an increase of an oil viscosity due to an over cooling is minimized. In addition, it is possible to prevent a solid contact by an oil film destroy in an interface which occurs due to the lack of the cooling water, and it is possible to extend the life span of the hydraulic pressure operation parts and gear irrespective of the driving condition of a vehicle.

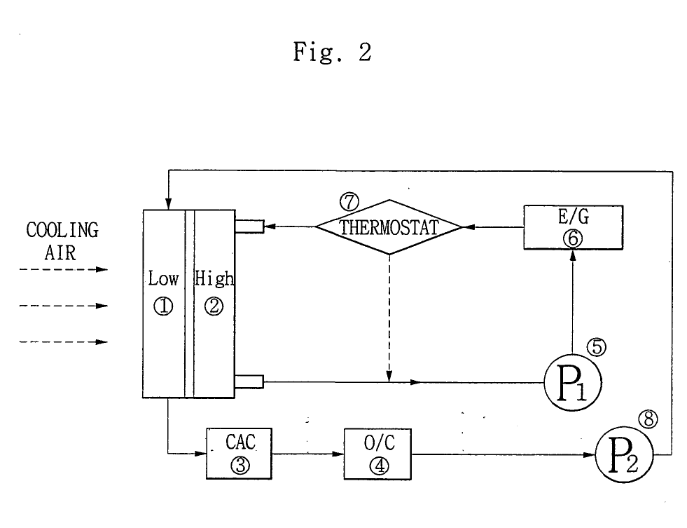

FIG. 2 is a view illustrating a high/low temperature water cooling system according to another embodiment of the present invention.

As shown therein, in the high/low water cooling system according to another embodiment of the present invention, the cooling water circulation path is divided into a high temperature cooling water circulation path in which the heat generated in the engine 6 of the vehicle is cooled and a low temperature cooling water circulation path in which the charge air cooler 3 and the oil cooler 4 are cooled. Namely, in the above separation type cooling system, the cooling water which flows through the low temperature heat exchanger 1 and the high temperature heat exchanger 2 is separately circulated by first and second water pumps 5 and 8. The high temperature cooling water circulation path is formed of the heat exchangers 1 and 2 integrally formed of the high temperature heat exchanger 2 and the low temperature heat exchanger 1, a first water pump 5 connected with an outlet of the high temperature heat exchanger 2, and a thermostat 7 installed at a bypass line separation point of the cooling water line which connects the outlet of the engine 6 with the high temperature heat exchanger 2. The low temperature cooling water circulation path is formed of a charge air cooler 3 connected with an outlet of the low temperature heat exchanger 1, an oil cooler 4 connected with an outlet of the charge air cooler 3, and a second water pump 8 connected with an outlet of the oil cooler 4 and transfers the cooling water discharged from the oil cooler 4 to the low temperature heat exchanger 1.

In the high/low temperature water cooling system according to another embodiment of the present invention, the cooling water is circulated based on the pumping operation of the first water pump 5 along the high temperature cooling water circulation path formed of the engine 6, the thermostat 7 and the high temperature heat exchanger 2 for thereby absorbing the combustion heat and cooling the engine. Differently from the high temperature cooling water circulation path, the cooling water is circulated and cooled based on the pumping operation of the second water pimp 8 in the low temperature cooling water circulation line formed of the low temperature heat exchanger 1, the charge air cooler 3 and the oil cooler 4.

The charge air cooler 3 heat-exchanges the charge air supplied to the engine combustion chamber with the low temperature cooling water cooled by the low temperature heat exchanger 1 and decreases to near the temperature of the atmosphere for thereby increasing the density of the charge air and increasing the combustion efficiency of the engine 6.

The oil cooler 4 heat-exchanges the cooling water discharged from the charge air cooler 3 with the flow-in oil for thereby increasing the temperature of the oil using the heat of the cooling water in the case that the temperature of the oil is low, and in the case that the oil is over-heated, the cooling water which has a relatively low temperature decreases the temperature of the oil, so that it is possible to maintain a constant oil temperature which is circulated along the oil circulation path.

The high/low temperature water cooling system according to the present invention controls the heat energy radiated into the air based oh the hardware by arranging each heat exchanger in consideration with the characteristics of the same, and the loss of the heat energy is minimized, the consumption of the fuel is decreased, and the mechanical efficiency is increased.

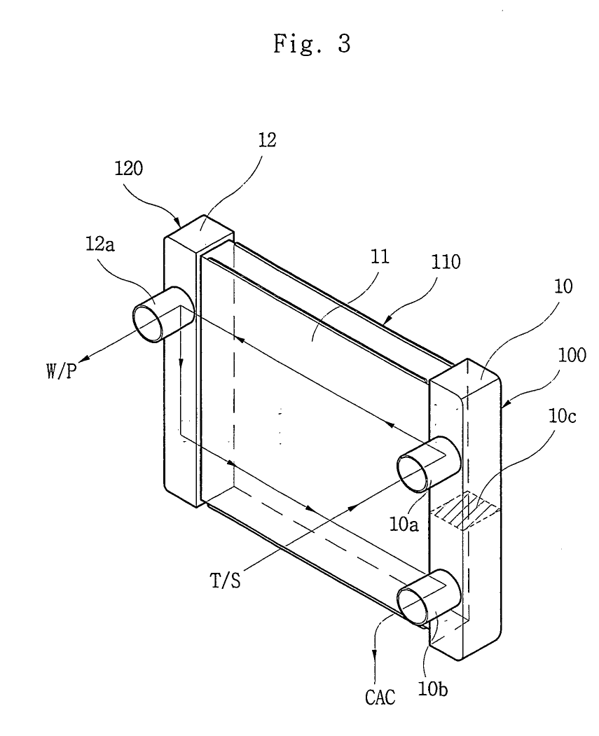

FIGS. 3 through 8 are rear side perspective views illustrating the heat exchangers adapted to the high/low temperature water cooling system (integration type high/low temperature water cooling system) according to an embodiment of the present invention and a high/low temperature water cooling system (separation type high/low temperature water cooling system) according to another embodiment of the present invention.

As shown in FIG. 3, the heat exchanger is adapted to the integration type high/low temperature water cooling system of FIG. 1 and includes an inlet tank 100 and outlet tank 120 arranged in parallel in a horizontal direction, and a heat radiating core 110 which connects the inlet tank 100 and the outlet tank 120 for flowing the cooling water and heat-exchanging the cooling water with an external air for thereby implementing a cooling operation.

The inlet tank 100 includes the interior divided into two spaces 10 and 15 arranged in upper and lower directions by a partition 100c. The inlet 100a connected with the thermostat (7 of FIG. 1) of the outlet side of the cooling water of the engine is installed in the upper space 10. A second discharging port 100b connected with the inlet of the charge air cooler (3 of FIG. 1) is installed in the lower space. In addition, a first discharging port 120a connected with the water pump (5 of FIG. 1) in the side of the inlet 100a of the inlet tank 10 is installed in the outlet tank 120. Therefore, the high temperature heat exchanger is formed of upper side elements 10, 11 and 12 of the inlet tank 100, the radiating core 110 and the outlet tank 120. The low temperature heat exchanger is formed of lower side elements 13, 14 and 15.

The cooling water discharged from the engine through the inlet 100a in the side of the inlet tank 100 is flown in and is first-cooled in the upper side element 11 of the heat radiating core 110, and a part of the cooling water is discharged (high temperature heat exchanger) in the side of the pump (5 of FIG. 1) through the first discharging port 120a of the outlet tank 120, and the remaining cooling water which is first-cooled flows through the lower side elements 13, 14 and 15 of the outlet tank 120, the heat radiating core 110 and the inlet tank 100 and is second-cooled and is discharged in the direction of the charge air cooler (3 of FIG. 1) through the second discharging port 100b.

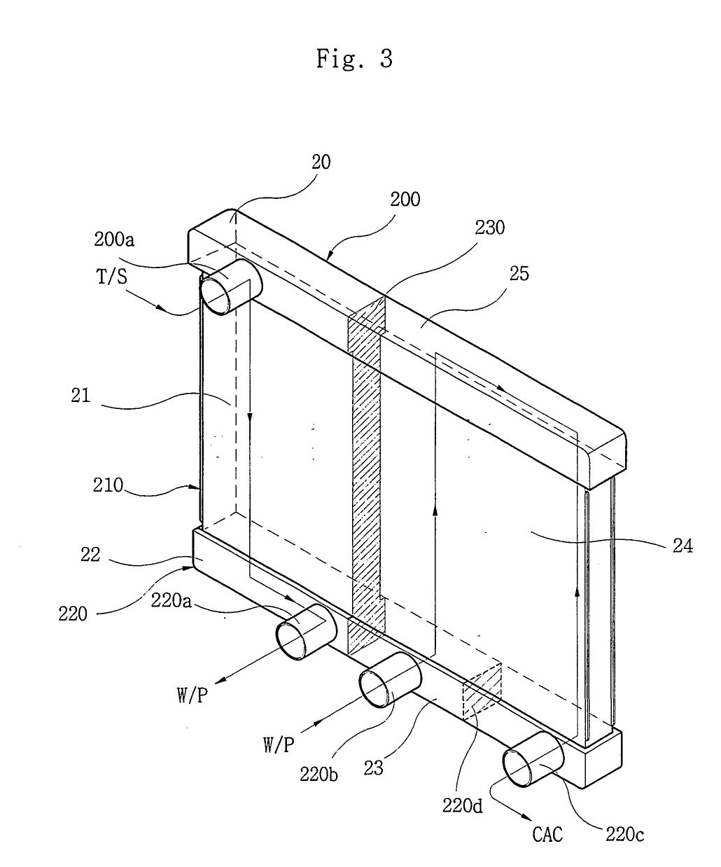

The heat exchanger of FIG. 4 is a heat exchanger adapted to both the integration type and separation type high/low temperature water cooling systems. In the above heat exchanger, the high temperature heat exchanger and the low temperature heat exchanger are arranged in the horizontal direction.

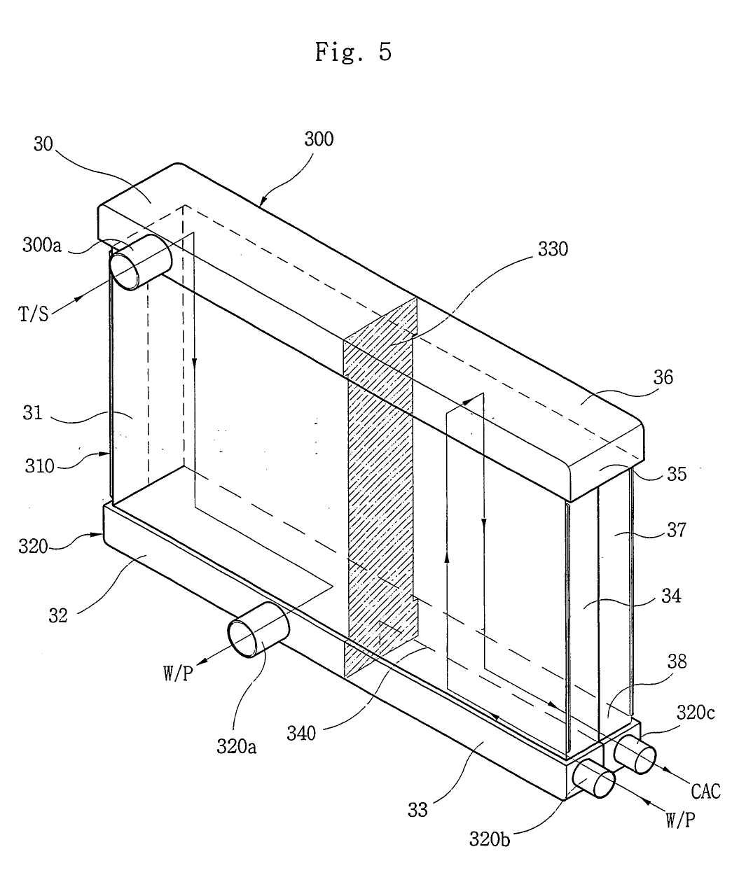

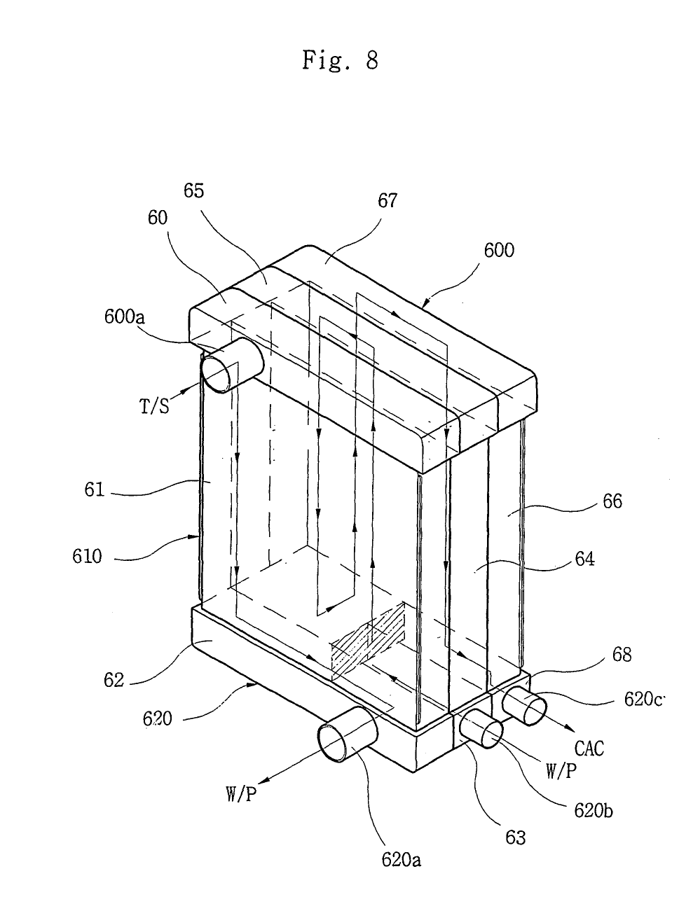

Namely, the above heat exchanger is formed of the inlet tank 200 and the outlet tank 220 which are arranged in parallel at a certain distance therebetween, and a heat radiating core 210 which connects the inlet tank 200 and the outlet tank 220. The inner space of the above heat exchanger is divided into the left and right spaces by a center partition 230. A first inlet 200a to which the discharging side of the thermostat (7 of FIGS. 1 and 2) of the discharging side of the engine is connected is installed in one side portion 20 of the inlet tank 200. A first outlet 220a to which an inlet side of the water pump (5 of FIGS. 1 and 5) is connected is installed in one side portion 22 of the outlet tank 220 in deviation with the first inlet 200a. In addition, the other side 23 of the outlet tank 220 is divided by the partition 220d. A second inlet 220b to which a discharging side of the water pump (5 of FIG. 1 or 8. of FIG. 2) is connected is installed in one side of the same. The second discharging port 220c to which the inlet side of the charge air cooler (3 of FIGS. 1 and 2) is connected is installed in the other side.

In the above construction, the cooling water of the engine is flown in through the first inlet 200a of the inlet tank 200 and is discharged in the direction of the water pump 5 through one side 21 of the radiating core 210 and the first discharging port 220a of the outlet tank 220 for thereby cooling the engine based on a heat exchange between the cooling water and an external air in the high temperature heat exchanger. The cooling water is flown in from the water pump (5 of FIG. 1) and the second water pump (8 of FIG. 2) through the second inlet 220b of the outlet tank 200 and is cooled by the other side 24 of the heat radiating core and is discharged in the direction of the charge air cooler (3 of FIGS. 1 and 2) through the second discharging port 220c.

The heat exchanger of FIG. 5 is a heat exchanger which is adapted to both the integration type and separation type high/low temperature cooling water system. The above heat exchanger is formed of a high temperature heat exchanger and a low temperature heat exchanger which are arranged in a horizontal direction.

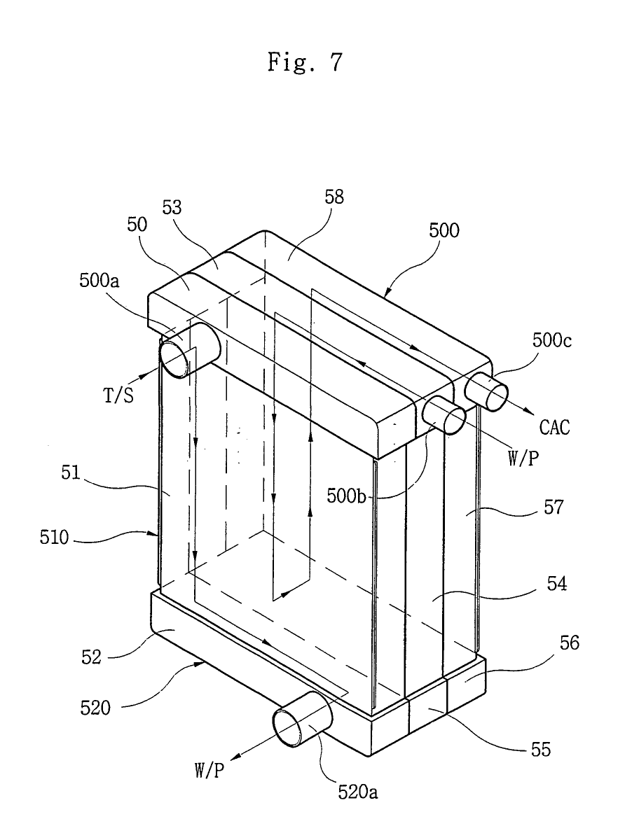

The above heat exchanger is formed of an inlet tank 300 and an outlet tank 320 which are arranged in parallel in the upper and lower portions at a certain distance therebetween, and a heat radiating core 310 which connects the inlet tank 300 and the outlet tank 320. The inner space of the same is divided into right and left spaces by a center partition 330. A first inlet 300a connected with a discharging side of the thermostat (2 of FIGS. 1 and 7 of FIG. 2) of the discharging side of the engine is installed in one side 30 of the inlet tank 300. In addition, a fist discharging port 320a connected with an inlet side of the water pump (5 of FIGS. 1 and 2) is installed in one side 32 of the outlet tank 320 in deviation with the first inlet 300a. A flow path is formed along the rear portion of the other side 34 of the heat radiating core 310, the front and rear portions 34 and 35 of the other side of the inlet tank 300, the rear portion 37 of the other side of the heat radiating core 310, and the rear portion 38 of the other side of the outlet tank 320 as the other side of the outlet tank 320 is divided into the front and rear directions by the partition 340. A second discharging port 320c connected with the inlet side of the charge air cooler (3 of FIGS. 1 and 2) is installed in the lateral side of the front and rear portions of the other side of the outlet tank 320. A second inlet 320b connected with a discharging side of the water pump (5 of FIGS. 1 and 8 of FIG. 20 is installed.

In the above construction, the cooling water of the engine is flown in through the first inlet 300a of one side 30 of the inlet tank 300 and is discharged in the direction of the water pump 5 through the one side 31 of the heat radiating core 310 and the first discharging port 320a of the outlet tank 320 for heat-exchanging the cooling water heated by the engine with an external air for thereby implementing a cooling operation (high temperature heat exchanger). The cooling water is flown in the direction of the rear portion 33 of the outlet tank 320 from the water pump (5 of FIG. 1) or the second water pump (8 of FIG. 2) through the second inlet 320b of the outlet tank 320 and is flown in a path formed along the rear portion 34 of the other side of the heat radiating core 310, the rear portion 35 and the front portion 36 of the other side of the inlet tank 300, the front portion 37 of the other side of the heat radiating core 300, and the front portion 38 of the other side of the outlet tank for thereby implementing a cooling operation (low temperature heat exchanger) and then the cooling water is discharged in the direction of the charge air cooler (3 of FIGS. 1 and 2) through the second discharging port 320c.

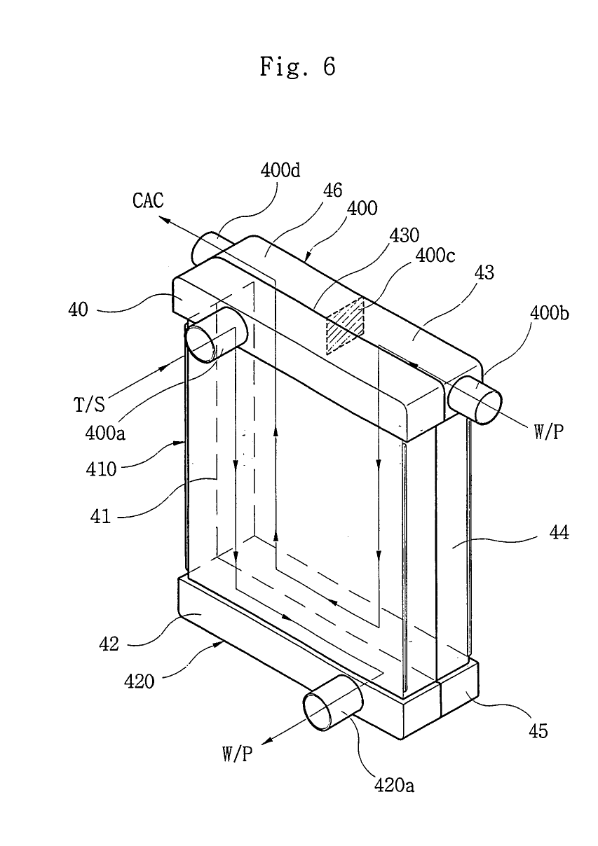

The heat exchanger of FIG. 6 is adapted to both the integration type and separation type high/low temperature water cooling system. The above heat exchanger is formed of a high temperature heat exchanger and a low temperature heat exchanger which are arranged in a forward and rearward directions.

As shown therein, the heat exchanger is formed of an inlet tank 400 and an outlet tank 420 which are arranged in parallel in the upper and lower portions at a distance therebetween, and a heat radiating core 410 which connects the inlet tank 400 and the outlet tank 420. An inner space of each of the tanks 400 and 420 is divided into a front and rear spaced by a center partition 430. A first inlet 400a connected with a discharging side of the thermostat (7 of FIGS. 1 and 2) is installed in one side of the rear portion 40 of the inlet tank 400. A first discharging port 420a connected with an inlet of the water pump (5 of FIGS. 1 and 2) is installed in the other side of the rear portion 42 of the outlet tank 420 in deviation with the first inlet 400a. The front portion 43 of the inlet tank 400 is divided into the left and right portions by the partition 400c. A second discharging port 400d connected with an inlet of the charge air cooler (3 of FIGS. 1 and 2) is installed in one side. A second inlet 400b connected with a discharging side of the water pump (5 of FIG. 1 or 8 of FIG. 2) is installed in the other side.

In the above construction, the cooling water of the engine is flown in through the first inlet 400a and is discharged in the direction of the water pump 5 through the rear portion 41 of the heat radiating core 410 and the first discharging port 420a of the rear portion 42 of the outlet tank 420 and heat-exchanges the cooling water heated by the engine with an external air (high temperature heat exchanger. In addition, the cooling water is flown in from the water pump (5 of FIG. 1) or the second water pump (8 of FIG. 2) through the second inlet 400b of the inlet tank 400 and flows along a path formed of the other side 44 of the heat radiating core 41, the front portion 45 of the outlet tank 420 and one side 46 of the heat radiating core 410 and is discharged in the direction of the charge air cooler (3 of FIGS. 1 and 2) through the second discharging port 400d.

The heat exchanger of FIG. 7 is a heat exchanger which is adapted to both the integration type and separation type systems. The above heat exchanger is formed of three spaces of the front portion, intermediate portion and rear portion in which the inlet tank 500, the outlet tank 520 and the heat radiating core 510 which are arranged in the forward and rearward directions for thereby forming a low temperature heat exchanger and a high temperature heat exchanger. Namely, the cooling water of the engine is flown from the thermostat (7 of FIGS. 1 and 2) through the first inlet 500a installed in one side of the rear portion 50 of the inlet tank 500 and is discharged in the direction of the water pump 5 through the rear portion 51 of the heat radiating core 510 and the first discharging port 520a of the rear portion 52 of the outlet tank 520, and the cooling water heated by the engine is heat-exchanged with an external air through the heat radiating core 510 (high temperature heat exchanger). The cooling water is flown in from the water pump (5 of FIG. 1) or the second water pump (8 of FIG. 2) through the second inlet 500b installed in the other side of the intermediate portion 53 of the inlet tank 500 and is flown along a path formed of the intermediate portion 54 of the heat radiating core 51, the intermediate portion 55 of the outlet tank 520, the front portion 56 of the outlet tank 520, the front portion 57 of the heat radiating core 510, and the front portion 58 of the inlet tank 500 and is discharged in the direction of the charge air cooler (3 of FIGS. 1 and 2) installed in the other surface of the front portion 58 of the inlet tank 500 for thereby heat-exchanging the cooling water with an external air through the intermediate portion 54 and the front portion 57 of the heat radiating core 550.

The heat exchanger of FIG. 8 is a heat exchanger adapted to both the integration type and separation type cooling system. The above heat exchanger is formed of three spaces of a front space, intermediate space and rear space in such a manner that the inlet tank 600, the outlet tank 620 and the heat radiating core 610 are arranged in the forward and rearward directions for thereby implementing a low temperature heat exchanger and a high temperature heat exchanger based on the divided spaces. The cooling water of the engine flown in through the first inlet 600a installed in one side of the rear portion 60 of the inlet tank 600 is flown into the thermostat (7 of FIGS. 1 and 2) and is discharged in the direction of the water pump (5 of FIGS. 1 and 2) through the rear portion 61 of the heat radiating core 610 and the first discharging port 620a of the rear portion 62 of the outlet tank 620 for thereby heat-exchanging the cooling water heated by the engine with an external air (high temperature heat exchanger). The cooling water is flown in from the water pump (5 of FIG. 1) and the second water pump (8 of FIG. 2) through the second inlet 620b installed in the other side surface of the intermediate portion 63 of the outlet tank 620 and is discharged in the direction of the charge air cooler (3 of FIGS. 1 and 2) through a path formed of an intermediate portion 63 of the outlet tank 620, the other side of the intermediate portion 64 of the heat radiating core 610, an intermediate portion 65 of the inlet tank 600, one side of the intermediate portion 64 of the heat radiating core 610, one side of the intermediate portion 63 of the outlet tank 620, on side of the intermediate portion 66 of the heat radiating core 610, a front portion 67 of the inlet tank 600, the other side of the front portion 66 of the heat radiating core 610, and the second discharging port 620c formed in one side surface of the front portion 68 of the outlet tank 620. Therefore, the cooling water is heat-exchanged with an external air through the intermediate portion 64 and the front portion 66 of the heat radiating core 610.

As described above, the heat exchangers used in the high/low temperature water cooling system according to the present invention divides the inner space into an inlet tank and an outlet tank using the partition for thereby artificially changing the circulation path of the cooling water, so that it is possible to increase the convection current heat transfer coefficient by forming a flux current and vertical cross movement component in the flow of the cooling water, and it is possible to increase the heat radiating performance by increasing the area of rhe heat transfer surface area per unit volume.

As a result of the test which is performed with respect to a heat radiating test for each heat exchanger in the same tester, the performance of the low temperature heat exchanger of the heat exchanger of FIG. 8 was best.

In the high/low temperature cooling water system according to the present invention, first it is possible to freely arrange and install each heat exchanger in a vehicle, and the construction of a pipe line of the cooling water is simplified. It is possible to significantly enhance an assembling performance of a vehicle cooling system, and a space efficiency is enhanced. Second, it is possible to cool an engine and charge air and oil using a high temperature cooling water and low temperature cooling water which are separately cooled to a high temperature water or a low temperature water based on each temperature characteristic, so that the loss of a heat energy due to an over heating is decreased, and a fuel consumption is decreased. It is possible to enhance a mechanical efficiency of a hydraulic operation element and a driving force system in which a mechanical friction occurs, and the life span is extended.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A high/low temperature water cooling system, comprising:
a heat exchanger integrally formed of a high temperature heat exchanger for cooling a cooling water flown in from an engine by heat-exchanging the cooling water with an external air and a low temperature heat exchanger for receiving a part of the cooling water, which is cooled and discharged from the high temperature heat exchanger, from a water pump and heat-exchanging the cooling water again with an external air;
a charge air cooler for receiving a cooling water from the low temperature heat exchanger and heat-exchanging the cooling water with a charge air from an engine combustion chamber and cooling the charge air;
an oil cooler for receiving a cooling water from the charge air cooler and heat-exchanging the cooling water with an oil which circulates along an oil circulation circuit;
a water pump for pumping a cooling water discharged from the high temperature heat exchanger and the oil cooler and transferring to a water jacket of the engine; and
a thermostat for inducing a cooling water discharged from the engine in the direction of the high temperature heat exchanger in the case that the temperature of the cooling water exceeds a certain reference temperature and bypassing the cooling water in the case that the temperature of the cooling water is below a certain reference temperature.

2. The system of claim 1, wherein said heat exchanger is formed of an inlet tank and an outlet tank arranged in parallel at a distance therebetween, and a heat radiating core for connecting the inlet tank and the outlet tank, flowing the cooling water and heat-exchanging the cooling water with an external air, wherein second discharging port connected with an inlet connected with a discharging side of the cooling water of the engine and an inlet of the charge air cooler is installed in a space formed in such a manner that the inner space of the inlet tank is divided into two spaces by a partition, and a first discharging port connected with the water pump is installed in the outlet tank in deviation with the inlet side, for thereby forming a high temperature heat exchanger in which a cooling water discharged from the engine through the inlet is flown and first cooled through the heat radiating core, and a part of the cooling water is discharged in the direction of the water pump through a first discharging port of the outlet tank, and a low temperature heat exchanger in which a remaining part of the first cooled cooling water is flown in to the heat radiating core and is second-cooled, and is discharged to the charge air cooled through the second discharging port.

3. The system of claim 1, wherein said heat exchanger includes an inlet tank and an outlet tank arranged in parallel at a certain distance therebetween, and a heat radiating core which connects the inlet tank and the outlet tank and flows the cooling water and heat-exchanges the cooling water with an external air, wherein the inlet tank, the outlet tank and the heat radiating core are separated in the left and right directions with respect to the same surface for thereby forming a high temperature heat exchanger in which the cooling water is discharged from the engine in the direction of the water pump which first-cools the cooling water as a part of the inlet tank, the outlet tank and the heat radiating core, and a low temperature heat exchanger in which the cooling water discharged from the water pump is second-cooled and is discharged in the direction of the charge air cooler as the other side of each of the inlet tank, the outlet tank and the heat radiating core.

4. The system of claim 1, wherein said heat exchanger includes an inlet tank and an outlet tank which are arranged in parallel at a certain distance therebetween, and a heat radiating core for connecting the inlet tank and the outlet tank and flowing the cooling water and heat-exchanging the cooling water with an external air, wherein front and rear portions are formed in which the inlet tank, the outlet tank and the heat radiating core are arranged in the front and rear directions with reference to the same surface, and a high temperature heat exchanger discharges the cooling water discharged from the engine in the direction of the water pump which first-cools the cooling water as a rear part of the inlet tank, the outlet tank and the heat radiating core, and a low temperature heat exchanger second-cools the cooling water discharged from the water pump and discharges into the direction of the charge air cooler as a front part of the inlet tank, the outlet tank and the heat radiating core.

5. The system of claim 1, wherein said heat exchanger includes an inlet tank and an outlet tank arranged in parallel at a certain distance therebetween, and a heat radiating core which connects the inlet tank and the outlet tank and flows the cooling water and heat-exchanges the cooling water with an external air, wherein a high temperature heat exchanger is divided into a front portion, intermediate portion and rear portion in which the inlet tank, the outlet tank and the heat radiating core are arranged in the forward and rearward directions with reference to the same surface and discharges the cooling water discharged from the engine in the direction of the water pump which first-cools the cooling water as a front part of the inlet tank, the outlet tank and the heat radiating core, and a low temperature heat exchanger second-cools the cooling water discharged from the water pump and discharged the cooling water in the side of the charge air cooler as each intermediate part and a rear part of the inlet tank, the outlet tank and the heat radiating core.

6. A high/low temperature water cooling system, comprising:
a heat exchanger which is integrally formed of a high temperature heat exchanger for heat-exchanging and cooling a cooling water flown in from an engine with an external air, and a low temperature heat exchanger which forms a separate cooling water line and receives a cooling water discharged from an oil cooler and heat-exchanges the cooling water with an external air;
a first water pump for pumping a cooling water discharged form the high temperature heat exchanger in the direction of the engine and circulating the same;
a thermostat for inducing the cooling water discharged from the engine in the direction of the high temperature heat exchanger in the case that the temperature of the cooling water exceeds a certain reference temperature and bypassing the cooling water using the first water pump in the case that the temperature of the same is below a certain reference temperature;
a charge air cooler for receiving a cooling water discharged from the low temperature heat exchanger and heat-exchanging with a charge air supplied to an engine combustion chamber and cooling the charge air;
an oil cooler for receiving a cooling water discharged from the charge air cooler and heat-exchanging with an oil which circulates along an oil circulation circuit; and
a second water pump for pumping the cooling water discharged from the oil cooler and circulating the pumped cooling water in the direction of the low temperature heat exchanger.

7. The system of claim 6, wherein said heat exchanger includes an inlet tank and an outlet tank arranged in parallel at a certain distance therebetween, and a heat radiating core which connects the inlet tank and the outlet tank and flows the cooling water and heat-exchanges the cooling water with an external air, wherein a high temperature heat exchanger is divided into a front portion, intermediate portion and rear portion in which the inlet tank, the outlet tank and the heat radiating core are arranged in the forward and rearward directions with reference to the same surface and discharges the cooling water discharged from the engine in the direction of the water pump which first-cools the cooling water as a front part of the inlet tank, the outlet tank and the heat radiating core, and a low temperature heat exchanger second-cools the cooling water discharged from the water pump and discharged the cooling water in the side of the charge air cooler as each intermediate part and a rear part of the inlet tank, the outlet tank and the heat radiating core.
